(19) United States
(12) Patent Application Publication
(10) Pub. No.: US 2015/0339371 A1
(43) Pub. Date: Nov. 26, 2015

(54) METHOD AND APPARATUS FOR CLASSIFYING SIGNIFICANT PLACES INTO PLACE CATEGORIES

(71) Applicants: Huanhuan CAO, Beijing (CN); Jilei TIAN, Beijing (CN)

(72) Inventors: Huanhuan CAO, Beijing (CN); Jilei TIAN, Beijing (CN)

(73) Assignee: Nokia Corporation, Espoo (FI)

(21) Appl. No.: 14/408,951

(22) PCT Filed: Jun. 28, 2012
(86) PCT No.: PCT/CN2012/077749

§ 371 Date: Dec. 17, 2014

(51) Int. Cl. G06F 17/30; G06N 99/00

(52) U.S. Cl. CPC G06F 17/30598; G06N 99/005

(57) ABSTRACT

An approach is provided for classifying significant places (stay points) into place categories. A classification platform determines user contextual information associated with at least one significant place. The classification platform further causes, at least in part, a comparison of the user contextual information against reference contextual information associated with one or more place categories. The classification platform also causes, at least in part, a classification of the at least one significant place into the one or more place categories based, at least in part, on the comparison.

### BACKGROUND

Service providers and device manufacturers (e.g., wireless, cellular, etc.) are continually challenged to deliver value and convenience to consumers by, for example, providing compelling network services. One such network service provides personalized location-based services to enhance user experience by customizing location-based information that is specifically relevant to a user (e.g., data that are customized and presented for personal needs considering user life style and inferred user preference). However, the user's current location may not have much significance to the user because services failed to recognize the rich social meanings of mined significant place location data of users. Accordingly, service providers and device manufacturers are challenged to develop new mechanisms for effectively and efficiently determining geographical locations relevant to a particular user's daily life and the coordinate user behaviors to utilize those geographical locations of interest and related information.

### SOME EXAMPLE EMBODIMENTS

Therefore, there is a need for an approach for classifying significant places into place categories.

According to one embodiment, a method comprises determining user contextual information associated with at least one significant place (stay point). The method also comprises causing, at least in part, a comparison of the user contextual information against reference contextual information associated with one or more place categories. The method further comprises causing, at least in part, a classification of the at least one significant place (stay point) into the one or more place categories based, at least in part, on the comparison.

According to another embodiment, an apparatus comprises at least one processor, and at least one memory including computer program code for one or more computer programs, the at least one memory and the computer program code configured to, with the at least one processor, cause, at least in part, the apparatus to determine user contextual information associated with at least one stay point. The apparatus also causes, at least in part, a comparison of the user contextual information against reference contextual information associated with one or more place categories. The apparatus is further causes, at least in part, a classification of the at least one stay point into the one or more place categories based, at least in part, on the comparison.

According to another embodiment, a computer-readable storage medium carries one or more sequences of one or more instructions which, when executed by one or more processors, cause, at least in part, an apparatus to determining user contextual information associated with at least one stay point. The apparatus also causes, at least in part, a comparison of the user contextual information against reference contextual information associated with one or more place categories. The apparatus further causes, at least in part, a classification of the at least one stay point into the one or more place categories based, at least in part, on the comparison.

According to another embodiment, an apparatus comprises means for determining user contextual information associated with at least one stay point. The apparatus also comprises means for causing, at least in part, a comparison of the user contextual information against reference contextual information associated with one or more place categories. The apparatus further comprises means for causing, at least in part, a classification of the at least one stay point into the one or more place categories based, at least in part, on the comparison.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of classifying significant places into place categories, according to one embodiment;

FIG. 2 is a diagram of the components of classification platform 103 for classifying significant places into place categories, according to one embodiment;

FIGS. 3A-H are a flowchart of a process for classifying significant places into place categories, according to one embodiment;

FIG. 4 is a diagram of an exemplary user interface utilized in the processes of FIG. 3, according to various embodiments;

FIGS. 5A-B are a flowchart diagram of a process for classifying significant places into place categories, according to one embodiment;

FIG. 6 is a diagram of a user interface utilized in the processes of FIG. 3, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for classifying significant places (stay points) into place categories are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “stay point” or “stationary point” refers to a cluster of location points from a predetermined period of time (e.g., a day, week, month, season, year, etc.) that represents a geographic region in which the user remains substantially stationary for some predetermined period of time. For example, a stay point is represented using the coordinates of the centroid of the cluster and the time interval when the user arrived and left the stay point, e.g., ([46.6N, 6.5E], [16:30:00], [17:54:34]). Generally, significant places indicate frequently visited stay points and may elicit a more meaningful location based recommendation.

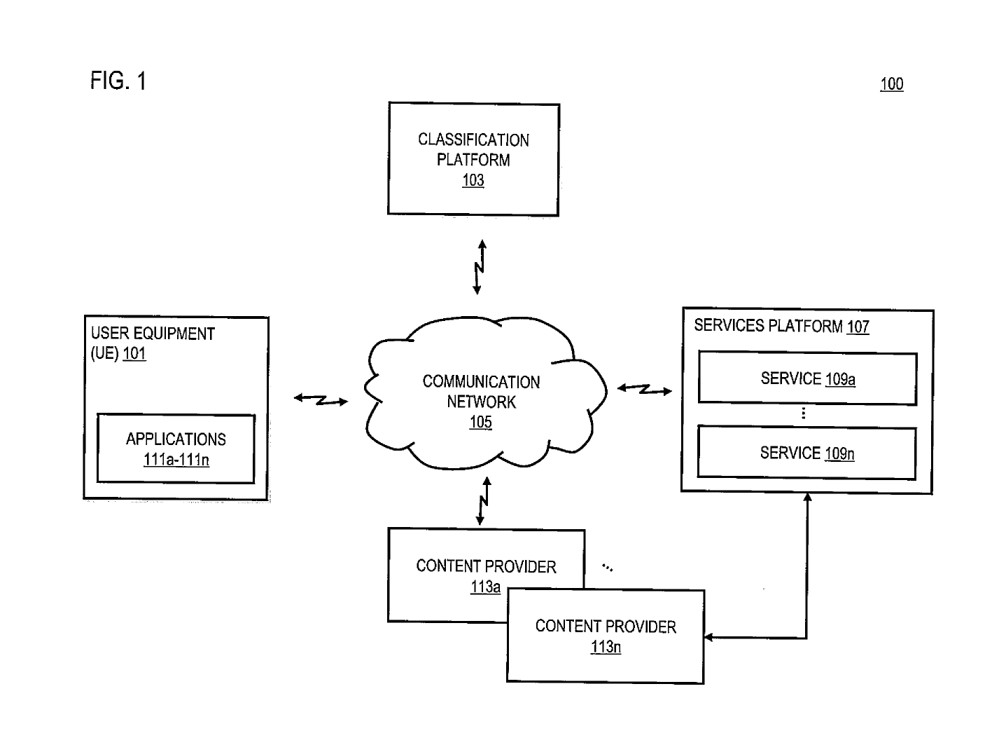

FIG. 1 is a diagram of a system capable of classifying significant places into place categories, according to one embodiment. For a network service to offer personalized location based user services information defining the rich social meaning of user significant places must be discovered in an efficient and unobtrusive manner that enhances overall user experience. A processing of available reference contextual information supports such a classifying of significant places into place categories. Generally, significant places indicate frequently visited stay points and may elicit a more meaningful location based recommendation. In some embodiments, the system is capable of classifying significant places, being a particular class representing frequently visited stay points, into categories. Further, in some embodiments, the system is capable of classifying significant places into categories.

To address this problem, a system 100 of FIG. 1 introduces the capability to advantageously discover, analyze, and classify user context information according to acquired reference context information or other data mining output to allow a classification platform 103 to discover the rich social meaning associated with user activities. Although mobile phones are equipped with sensors for automatic recognition of personally relevant locations, these services require user interaction to determine user significant places. Limiting required user interaction via utilization of network services, applications, and content providers provides for enhanced user experience.

As shown in FIG. 1, the system 100 comprises a user equipment (UE) 101 having connectivity to a classification platform 103, a services platform 107, and a content platform 113 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101 may execute one or more applications 111a-111n (collectively referred to as applications 111). The applications 111 may be any type of application, such as one or more social networking applications, one or more navigational applications, one or more calendar applications, one or more browsing applications (e.g., Internet browser), one or more sensor applications, etc., or a combination thereof. In one embodiment, one or more applications 111 may perform any one or more of the functions of the classification platform 103 discussed below.

The system 100 may also include a services platform 107 that includes one or more services 109a-109n (collectively referred to as services 109). The services 109 may be any type of service, such as one or more social networking services, one or more navigational services, one or more calendar services, one or more sensor services, etc., or a combination thereof. In one embodiment, one or more services 109 may perform any one or more of the functions of the classification platform 103. In one embodiment, the classification platform 103 may provide information pertaining to one or more user associated significant places, and/or one or more reference contextual information to one or more of the services 109 so that the services 109 may provide personalized services associated with the significant places to the user.

The system 100 may also include one or more content providers 113a-113n (collectively referred to as content providers 113). The content providers 113 may provide any type of content, such as content related to social networking services, one or more navigational services, one or more calendar services, one or more sensor services, etc., or a combination thereof. In one embodiment, the classification platform 103 may provide information pertaining to one or more user associated significant places, and/or one or more reference contextual information to one or more of the content providers 113 so that the content providers 113 may provide personalized content associated with the significant places to the user.

By way of example, the UE 101, the classification platform 103, the services platform 107 and the content provider 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

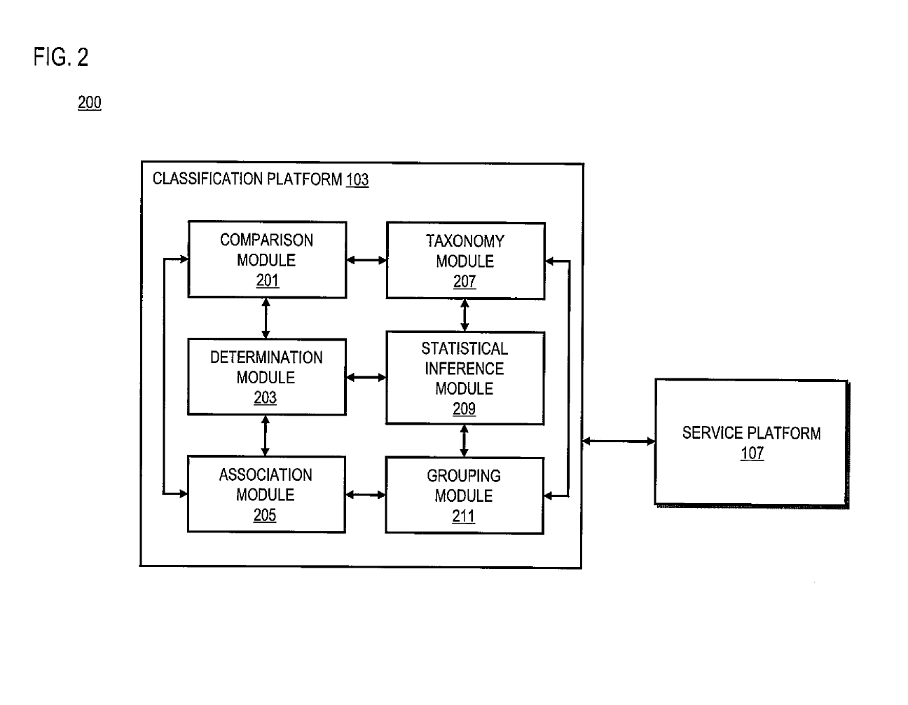

FIG. 2 is a diagram of the components of classification platform 103 for classifying significant places (stay points) into place categories according to one embodiment. By way of example, the classification platform 103 includes one or more components for classifying significant places into place categories. Generally, significant places indicate frequently visited stay points and may elicit a more meaningful location based recommendation. In some embodiments, the system is capable of classifying significant places and/or stay points into categories. It is contemplated that the functions of these components may be combined in one or more components or performed by other components of equivalent functionality. For example, one or more functions of these components may be performed by any one or more of the UE 101, applications 111 on the UE 101, services 109, and/or content providers 113. In this embodiment, the classification platform 103 includes a comparison module 201, a determination module 203, an association module 205, a taxonomy module 207, a statistical inference module 209, and a grouping module 211.

The comparison module 201 interfaces with network components to analyze user contextual information against reference contextual information associated with one or more place categories. The classification platform 103 functions, at least in part, to render a classification of a stay point into one or more place categories based, at least in part, on comparison module 201 output. By way of example, comparison module 201 interfaces with determination module to determine one or more candidate categories from among the one or more categories based, at least in part, on the comparison module 201 output.

The determination module 203 interfaces with network components to render one or more candidate categories from among the one or more categories based, at least in part, on the comparison module output. Further, determination module 203 processes user contextual information associated with at least one stay point. By way of example, determination module 203 renders one or more candidate categories for the classification of a stay point by interfacing with statistical inference module 209 to process points of interest in proximity to a stay point.

The association module 205 renders a relationship between reference contextual information with the one or more place categories based, at least in part, on a classification of the one or more reference significant places (stay points) into the one or more place categories. By way of example, reference contextual information is provided to the classification platform 103 via mined data collection in any available iteration.

The taxonomy module 207 renders a taxonomy for one or more place categories based, at least in part, on one or more semantic meanings, one or more labels, or a combination thereof that are to be associated via association module 205 with at least one stay point. By way of example, a taxonomy may be determined or provided by a processing of mined or provided data by a service provider, by at least one user, or a combination thereof. Taxonomy module 207 may be dynamic in that it functions to continuously fine tune a taxonomy by accounting for even incremental deviations over any period of time.

The statistical inference module 209 manipulates probability information to determine that the one or more place categories are applicable to the at least one stay point to interface with classification platform 103 to classify a stay point. By way of example, comparison module 201 may function cooperatively with network components to render a hierarchical ranking of possible stay point classification. Statistical inference module 209 renders a meaningful probability that may be useful to a user according to adjusted probability parameters.

The grouping module 211 relates classification categories according to system parameters defined by a service provider, a user, content provider 113, services platform 107, or a combination thereof. By way of example, grouping module 211 may relate classification categories according to their rich social meaning. In an exemplary embodiment, categories may be grouped according to whether corresponding significant places and/or representative stay points are public or private according to the confines presented in analyzed reference and/or user contextual information.

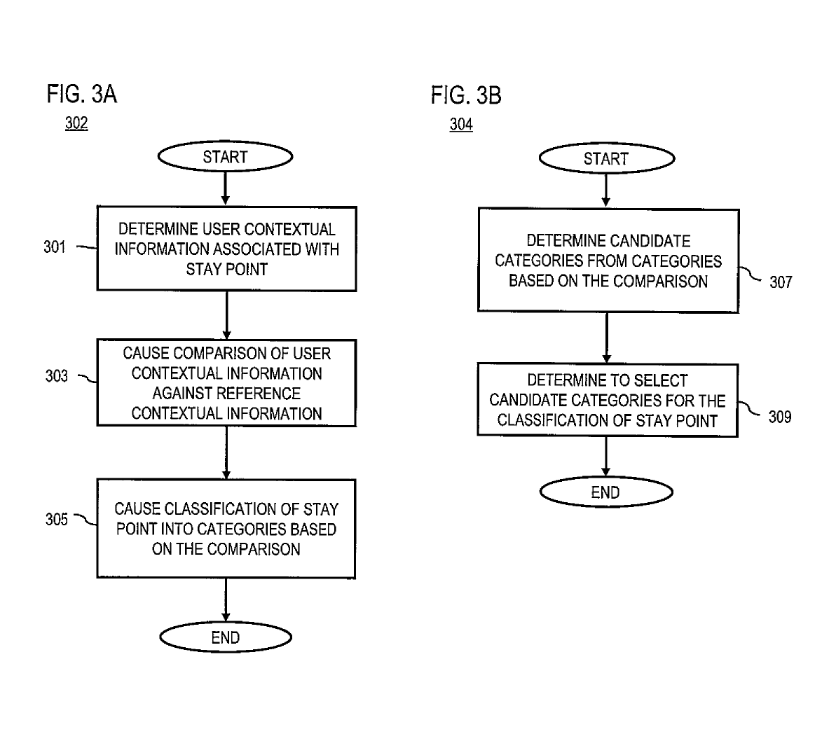

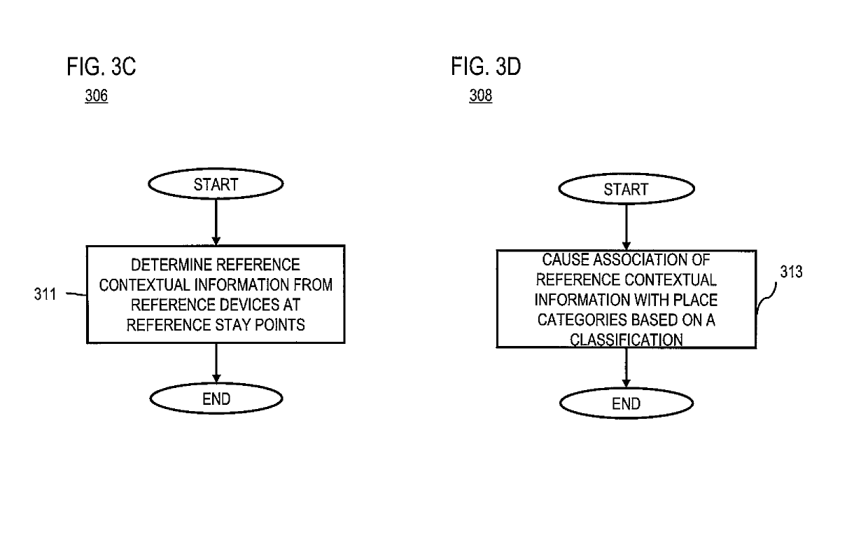

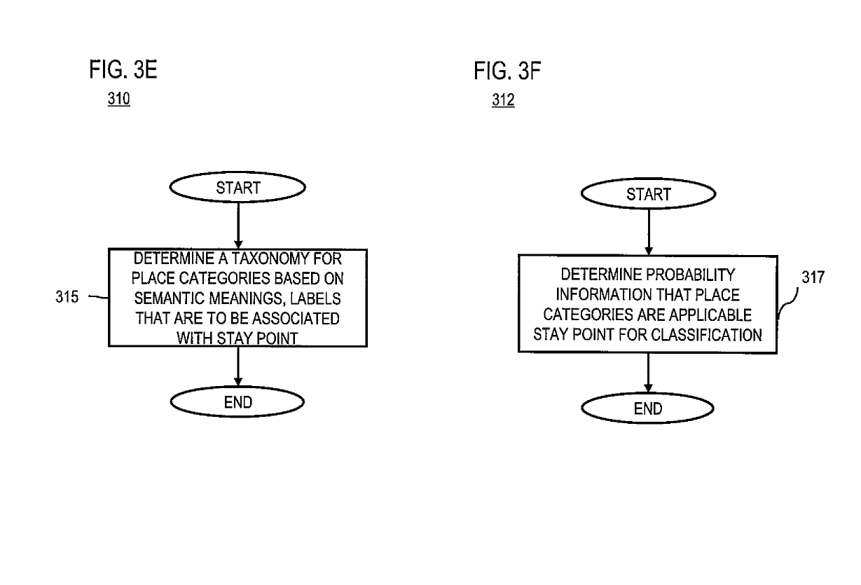

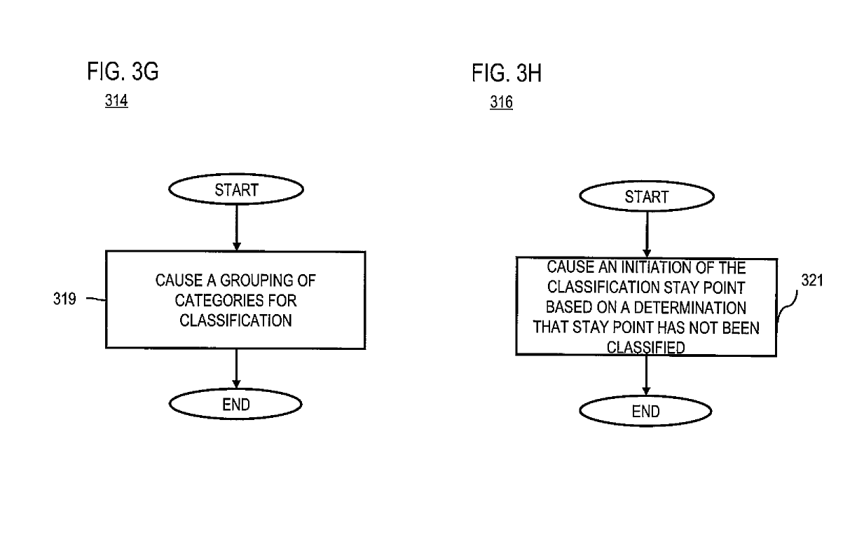

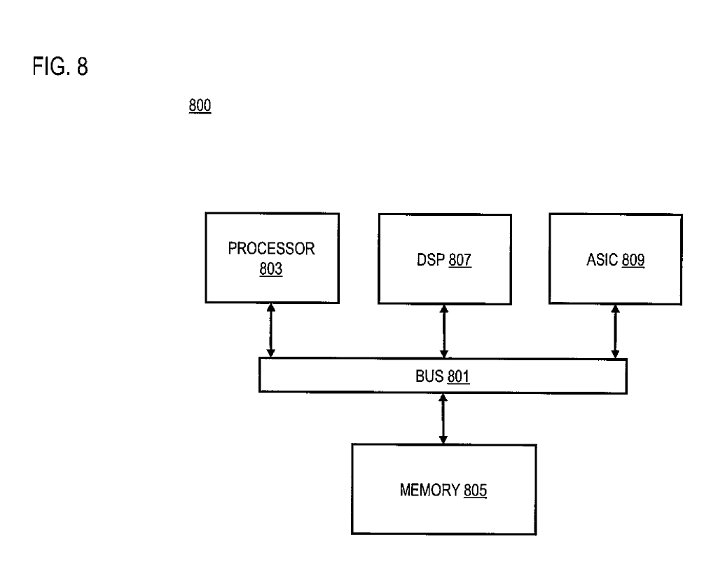

FIG. 3 is a flowchart of a process for classifying significant places into place categories, according to one embodiment. In one embodiment, the classification platform 103 performs the process 300 and is implemented in, for instance, a chip set including a processor and a memory as shown in FIG. 8. Generally, significant places indicate frequently visited stay points and may elicit a more meaningful user function. In some embodiments, the system is capable of classifying significant places into categories. In step 301, determination module 203 facilitates a determination of user contextual information that has been provided via association module 205 with at least one significant place, at least one stay point, or a combination thereof. In step 303, comparison module 201 renders a relationship relating user contextual information coordinately with reference contextual information outputted from association module 205 with one or more place categories. In step 305, classification platform 103 renders a classification of the at least one stay point into the one or more place categories based, at least in part, on the comparison module 201 output.

In step 307, determination module 203 renders one or more candidate categories from among the one or more categories based, at least in part, on the comparison. In step 309, determination module 203 outputs one of the one or more candidate categories for the classification of the at least one stay point based, at least in part, on whether the one or more candidate categories at least substantially matches the one or more categories that are associated with one or more points of interest within proximity of the at least one stay point.

In step 311, determination module 203 functions coordinately with the classification platform 103 to allow a processing of reference contextual information from one or more reference devices while the one or more reference devices are at one or more reference stay points.

In step 313, association module facilitates an association of the reference contextual information with the one or more place categories based, at least in part, on a classification, according to classification platform 103, of the one or more reference stay points into the one or more place categories.

In step 315, taxonomy module 207 determines a taxonomy for the one or more place categories based, at least in part, on one or more semantic meanings, one or more labels, or a combination thereof that are to be associated via association module 205 with the at least one stay point.

In step 317, determination module 203 functions coordinately with statistical inference module 209 to render probability information defining that the one or more place categories are applicable to the at least one stay point. In step 319, grouping module 211 causes a grouping of at least some of the one or more categories according to classification platform 103 parameters.

In step 321, causing, at least in part, an initiation of the classification of the at least one stay point based, at least in part, on a determination that the at least one stay point has not been classified.

FIG. 4 is a diagram of an exemplary user interface 400 utilized in the processes of FIG. 3, according to various embodiments. Many mobile service providers can obtain user trajectories (GPS sequence and cell ID sequence) form their mobile devices. Many existing approaches can discover the significant places of users where they have frequently visited from these trajectories. The classification platform 103 with determination module 203 interfaces with the UE 101 to determine the logs of base stations that the UE 101 may have communicated with to determine the base station identifiers to process for determining the significant places.

The base station logs may include the base station identifier and a time that the UE 101 communicated with the base station. Optionally, the base station logs may include additional information, such as the service provider that is associated with the base station. Using the log information, the determination module 203 determines a base station trajectory that indicates the base stations that communicated with the UE 101 in a linear progression based on time.

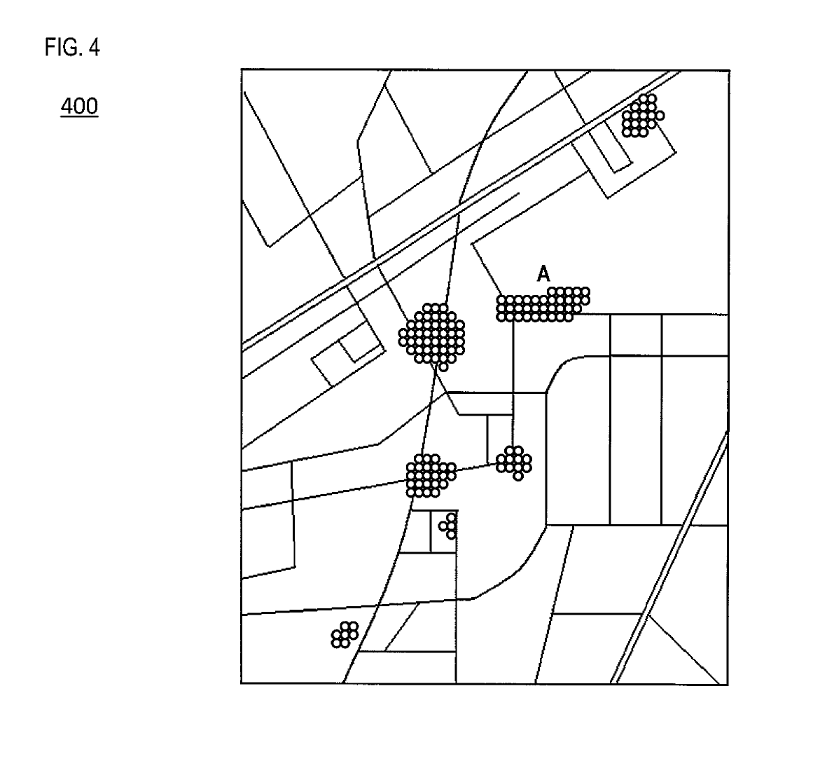

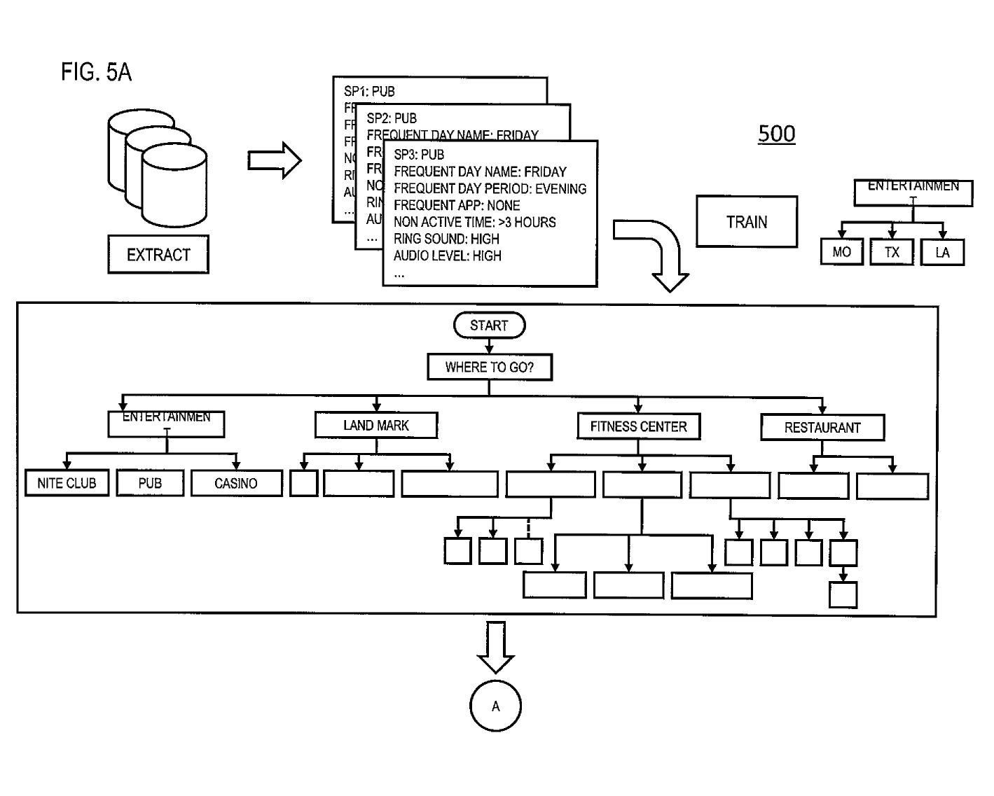

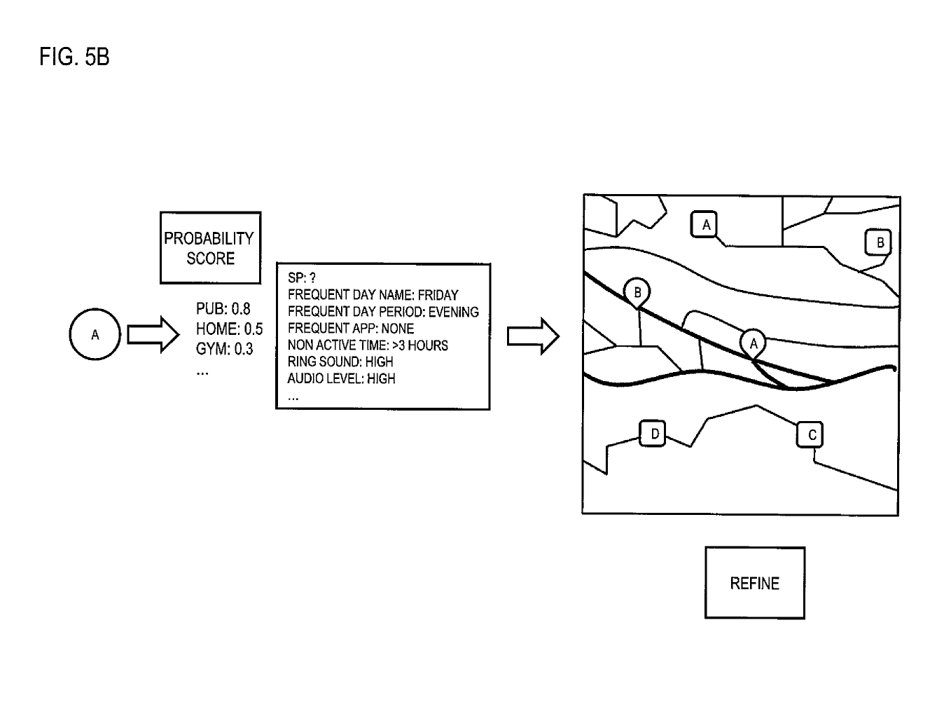

FIGS. 5A-B are a flowchart diagram of a process 500 for classifying significant places into place categories, according to one embodiment. By way of example, user context information is leveraged to classify significant places into place categories in order to better understand user behavior to offer personalized services and infer user preferences. According to an exemplary embodiment depicted in FIG. 5A, to determine user contextual information, classification platform 103 in conjunction with network components collect defined significant places from one or more users via any available data mining technique. In one embodiment significant places are extracted from collected significant place contextual information from data collection volunteers in order to train a significant place classifier to classify significant places according to the corresponding reference context data. One such data mining technique employs utilizing user trajectories processed by classification platform 103.

In one embodiment, for a significant place, classification platform 103 facilitates determination of several candidate points of interest (POI) within proximity of the at least one stay point. Accordingly, classification platform 103 utilizes the place categories of the candidate POIs as candidate place categories. Such training methodologies may employ any available decision support tool for evaluating decisions and their possible consequences.

In one embodiment, classification platform 103 employs a trained significant place classifier to select a probable place category from the candidate categories according to user parameters, classification platform parameters, service provider parameters, or a combination thereof. By way of example, classification platform 103 may cause, at least in part, a comparison of the user contextual information against reference contextual information provided by determination module 203 to be associated with one or more place categories. In a further embodiment, classification platform leverages traditional classification models such as any available related supervised learning methods that analyze data and recognize patterns, used for classification (e.g., Decision Tree, Support Vector Machine, Bayes Network, etc.). In some embodiments. Classification platform 103 employs a hierarchical semantic taxonomy, as depicted in FIG. 5A, of significant place categories in rendering a classifier. As such, statistical inference module 209 determines probability information, as depicted in FIG. 5B, according to one or more place categories applicable to a stay point and/or a significant place for selection by classification platform 103, user approval via a user input, or a combination thereof.

According to one embodiment, data is collected in the form of contextual information from one or more users, one or more reference sources, or a combination thereof to train significant place classifier. By way of example, determination module 203 facilitates collection of reference contextual information from one or more reference devices while the one or more reference devices are at one or more reference significant places. Such a determination may function to define a taxonomy of place categories, such as “Home”, “Work”, “Restaurant”, “Gym”, “Pub”, “Other”, etc. As such, taxonomy module 207 in coordination with determination module 203 determine a taxonomy for the one or more place categories based, at least in part, on one or more semantic meanings, one or more labels, or a combination thereof that are to be associated with the at least one stay point.

In a further embodiment, volunteers representing different subsets within a population may install an application in their devices for collecting their location trajectories and rich context data. Such rich context data may collect information regarding time, executed functions, application launch and use, web history, call logs, usage area environmental factors (e.g., background noise level, sensor information, weather information, etc.). After a dynamic or defined period, reference user contextual information may be mined for significant place determination via collected location trajectories. Further, such mined information may include rich social meanings including, but not limited to, taxonomy information, category information, semantic meaning information, label information, or a combination thereof, which may be used for training a significant place classifier. By way of example, taxonomy module 207 may determine a taxonomy specified by at least one service provider, at least one user, or a combination thereof.

In a further embodiment, where reference contextual information having rich social meaning is determined via determination module 203, classification platform 103 may leverage traditional classification models to classify significant places into place categories. As such, association module 205 processes reference contextual information with the one or more place categories based, at least in part, on a classification of the one or more reference significant places (and/or stay points) into the one or more place categories. Significant place classifier may be employed to calculate probability scores for each candidate place category of a given significant place. Such a hierarchical list may be employed to classify a stay point according to determined parameters, user input, or a combination thereof. By way of example, a grouping of one or more categories may be based, at least in part, on at least one hierarchy of the one or more categories.

In a further embodiment, determination module 203 may facilitate an output that at least one stay point has not been classified. In such an embodiment, classification platform 103 may cause an initiation of the classification of the yet to be classified stay point according to place categories of candidate POIs in the vicinity of an unclassified stay point as candidate place categories as previously discussed. As such, classification platform 103 may employ any available decision support tool for evaluating a classification.

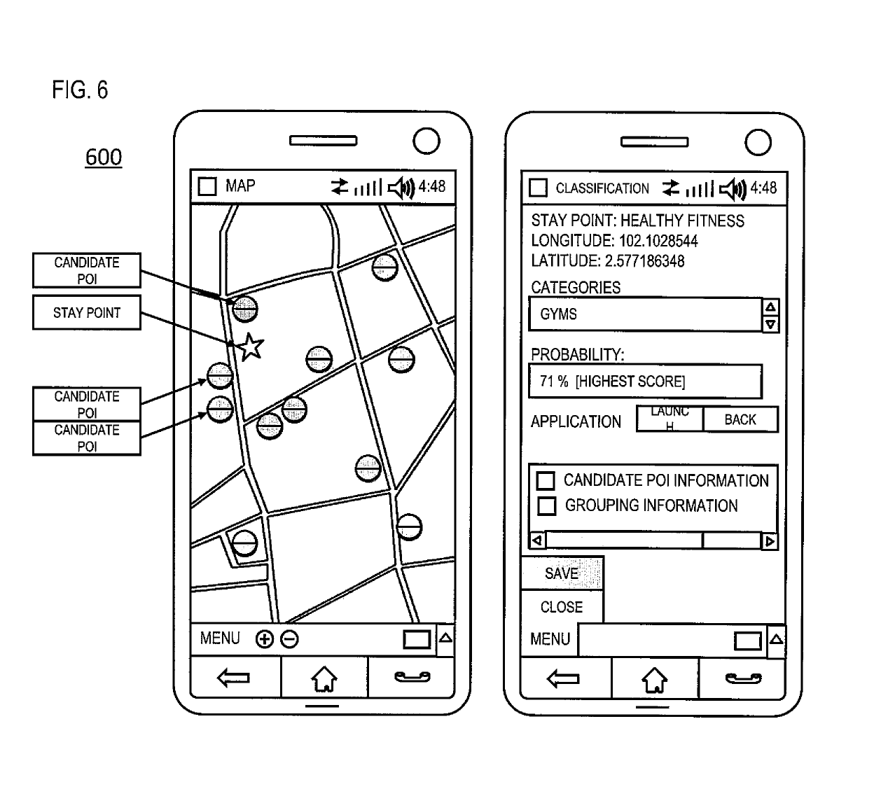

FIG. 6 is a diagram of a user interface utilized in the processes of FIG. 3, according to various embodiments. The user interface 600 may display several significant places (collectively referring to a particular class of frequently visited stay points) that the classification platform 103 has determined according to any available data mining and/or acquisition methodologies, such as, but not limited to, utilizing user trajectories via the log of base station identifiers. In one embodiment, stay point indicates one of a cluster of location points from a predetermined period of time (e.g., a day, week, month, season, year, etc.) that represents a geographic region in which the user remains substantially stationary for some predetermined period of time. As illustrated, the significant places are composed of discrete locations defining STAY POINT and CANDIDATE POI according to the behavior of one or more users. The classification platform 103 may then transmit this information to, for example, one or more services 109 and/or content providers 113 such that one or more service providers may provide personalized information with respect to a user's significant places.

The processes described herein for classifying significant places into place categories may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

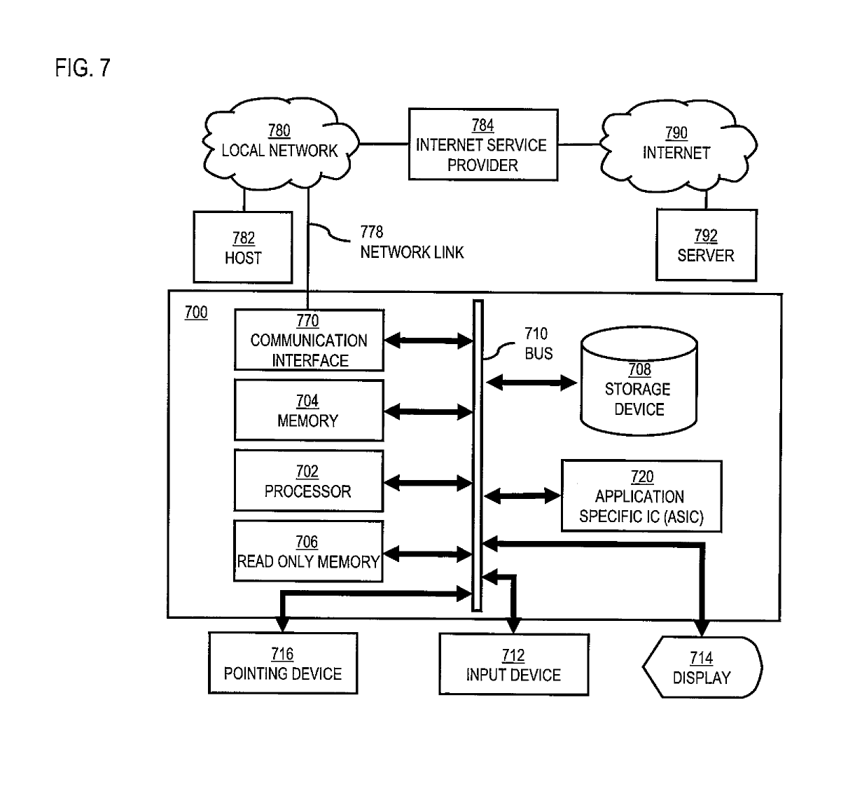

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to classifying significant places into place categories as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (quoit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of classifying significant places into place categories.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to classifying significant places into place categories. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for classifying significant places into place categories. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for classifying significant places into place categories, is provided to the bus 710 for use by the processor from an external input device 712, such as a keyboard containing alphanumeric keys operated by a human user, a microphone, an

Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for classifying significant places into place categories to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to classify significant places into place categories as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of classifying significant places into place categories.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to classify significant places into place categories. The memory 805 also stores the data associated with or generated by the execution of the inventive steps.

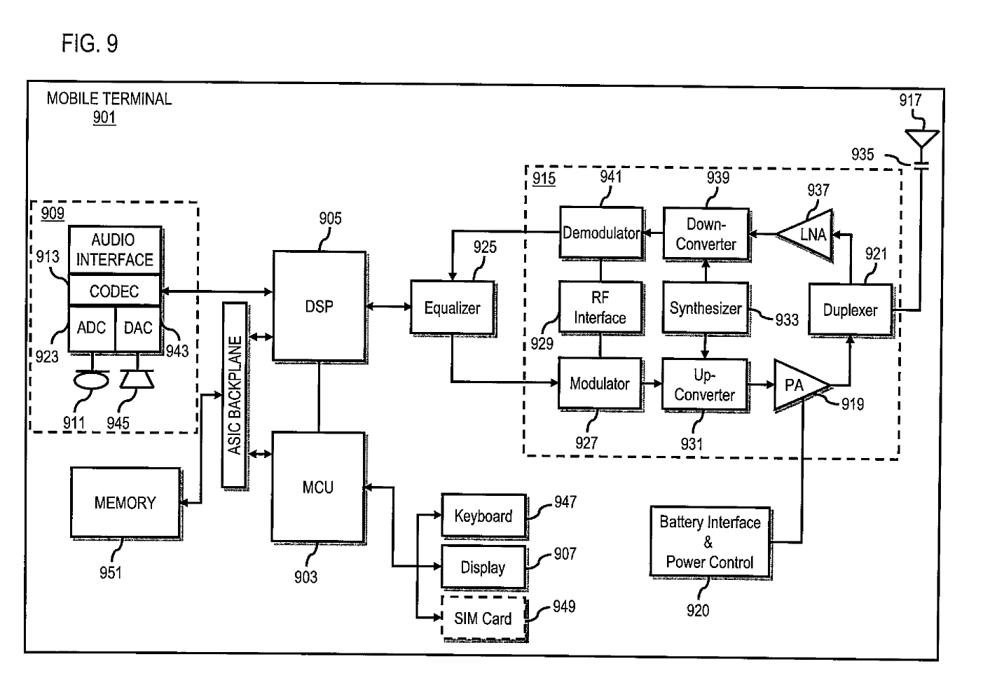

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of classifying significant places into place categories. Generally, a radio receiver is often defined in terms of front-end and back-end characteristics.

The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This defmition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of classifying significant places into place categories. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideb and code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to classify significant places into place categories. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising facilitating a processing of and/or processing (1) data and/or (2) information and/or (3) at least one signal, the (1) data and/or (2) information and/or (3) at least one signal based, at least in part, on the following:
at least one determination of user contextual information associated with at least one stay point;
a comparison of the user contextual information against reference contextual information associated with one or more place categories; and
a classification of the at least one stay point into the one or more place categories based, at least in part, on the comparison.

40. A method of claim 39, wherein the (1) data and/or (2) information and/or (3) at least one signal are further based, at least in part, on the following:
at least one determination of one or more candidate categories from among the one or more place categories based, at least in part, on the comparison; and
at least one determination to select at least one of the one or more candidate categories for the classification of the at least one stay point based, at least in part, on whether the one or more candidate categories at least substantially matches the one or more place categories that are associated with one or more points of interest within proximity of the at least one stay point.

41. A method of claim 39, wherein the (1) data and/or (2) information and/or (3) at least one signal are further based, at least in part, on the following:
at least one determination of the reference contextual information from one or more reference devices while the one or more reference devices are at one or more reference stay points.

42. A method of claim 41, wherein the (1) data and/or (2) information and/or (3) at least one signal are further based, at least in part, on the following:
an association of the reference contextual information with the one or more place categories based, at least in part, on a classification of the one or more reference stay points into the one or more place categories,
wherein the comparison, the classification, or a combination thereof is based, at least in part, on the association.

43. A method of claim 39, wherein the (1) data and/or (2) information and/or (3) at least one signal are further based, at least in part, on the following:
at least one determination of a taxonomy for the one or more place categories based, at least in part, on one or more semantic meanings, one or more labels, or a combination thereof that are to be associated with the at least one stay point.

44. A method of claim 43, wherein the taxonomy is specified by at least one service provider, at least one user, or a combination thereof.

45. A method of claim 39, wherein the (1) data and/or (2) information and/or (3) at least one signal are further based, at least in part, on the following:
at least one determination of probability information that the one or more place categories are applicable to the at least one stay point,
wherein the classification of the at least one stay point into the one or more place categories is based, at least in part, on the probability information.

46. A method of claim 39, wherein the (1) data and/or (2) information and/or (3) at least one signal are further based, at least in part, on the following:
causing, at least in part, a grouping of at least some of the one or more place categories,
wherein the classification of the at least one stay point is based, at least in part, on the grouping.

47. A method of claim 46, wherein the grouping is based, at least in part, on at least one hierarchy of the one or more place categories.

48. A method of claim 39, wherein the (1) data and/or (2) information and/or (3) at least one signal are further based, at least in part, on the following:
an initiation of the classification of the at least one stay point based, at least in part, on a determination that the at least one stay point has not been classified.

49. An apparatus comprising:
at least one processor; and
at least one memory including computer program code for one or more programs,
the at least one memory and the computer program code configured to, with the at least one processor, cause the apparatus to perform at least the following,
determine user contextual information associated with at least one stay point;
cause, at least in part, a comparison of the user contextual information against reference contextual information associated with one or more place categories; and
cause, at least in part, a classification of the at least one stay point into the one or more place categories based, at least in part, on the comparison.

50. An apparatus of claim 49, wherein the apparatus is further caused to:
determine one or more candidate categories from among the one or more place categories based, at least in part, on the comparison; and
determine to select at least one of the one or more candidate categories for the classification of the at least one stay point based, at least in part, on whether the one or more candidate categories at least substantially matches the one or more place categories that are associated with one or more points of interest within proximity of the at least one stay point.

51. An apparatus of claim 49, wherein the apparatus is further caused to:
determine the reference contextual information from one or more reference devices while the one or more reference devices are at one or more reference stay points.

52. An apparatus of claim 51, wherein the apparatus is further caused to:
cause, at least in part, an association of the reference contextual information with the one or more place categories based, at least in part, on a classification of the one or more reference stay points into the one or more place categories,
wherein the comparison, the classification, or a combination thereof is based, at least in part, on the association.

53. An apparatus of claim 49, wherein the apparatus is further caused to:
determine a taxonomy for the one or more place categories based, at least in part, on one or more semantic meanings, one or more labels, or a combination thereof that are to be associated with the at least one stay point.

54. An apparatus of claim 53, wherein the taxonomy is specified by at least one service provider, at least one user, or a combination thereof.

55. An apparatus of claim 49, wherein the apparatus is further caused to:
determine probability information that the one or more place categories are applicable to the at least one stay point,
wherein the classification of the at least one stay point into the one or more place categories is based, at least in part, on the probability information.

56. An apparatus of claim 49, wherein the apparatus is further caused to:
cause, at least in part, a grouping of at least some of the one or more place categories,
wherein the classification of the at least one stay point is based, at least in part, on the grouping.

57. An apparatus of claim 56, wherein the grouping is based, at least in part, on at least one hierarchy of the one or more place categories.

58. An apparatus of claim 49, wherein the apparatus is further caused to:
cause, at least in part, an initiation of the classification of the at least one stay point based, at least in part, on a determination that the at least one stay point has not been classified.
